(19) United States
(12) Patent Application Publication
(10) Pub. No.: US 2015/0060107 A1
(43) Pub. Date: Mar. 5, 2015

(54) HALOGEN-FREE RESIN COMPOSITION, INSULATED WIRE AND CABLE

(71) Applicant: Hitachi Metals, Ltd., Tokyo (JP)

(72) Inventors: Makoto Iwasaki, Tokyo (JP); Kenichiro Fujimoto, Tokyo (JP)

(21) Appl. No.: 14/472,082

(22) Filed: Aug. 28, 2014

(30) Foreign Application Priority Data
Aug. 30, 2013 (JP) 2013-179346

(51) Int. Cl. H01B 3/42; C08K 5/5419; H01B 7/295; C08K 3/22

(52) U.S. Cl. CPC H01B 3/427; H01B 3/423; C08K 3/22; C08K 5/5419; H01B 7/295; C08K 2003/2241; C08K 2003/2224
USPC 174/110 SR; 528/308.6; 528/298; 528/212; 524/436; 524/267

(57) ABSTRACT

A halogen-free resin composition includes an engineering plastic as a main component including an aromatic ring. A thermal weight-change rate measured by a thermogravimetry (under conditions that a dry air as a purge gas is introduced and that heating is conducted from 40° C. at a temperature rise rate of 10° C./min) is not less than −60% when it is 430° C.

The present application is based on Japanese patent application No. 2013-179346 filed on Aug. 30, 2013, the entire contents of which are incorporated herein by reference.

### BACKGROUND OF THE INVENTION

1. Field of the Invention

The invention relates to a halogen-free flame-retardant resin composition as well as an insulated wire and a cable that include a covering layer including the resin composition.

2. Description of the Related Art

Electric wires or cables which are disposed near an engine or motor in railroad rolling stocks or automobiles etc. are required to have characteristics such as heat resistance, abrasion resistance and flame retardancy on an as-needed basis. In order to meet such requirements, engineering plastics having high melting point etc. are sometimes used. It is known that halogen-based or phosphorus-based flame retardants are used to allow the flame-retardancy of the engineering plastics.

However, halogen-based flame retardants produce a halogen gas at the time of combustion and use thereof thus exhibits a lack of concern for globally growing environmental issues. Meanwhile, phosphorus-based flame retardants such as red phosphorus generate phosphine at the time of combustion or produce phosphoric acid when discarded, raising concerns of groundwater contamination.

Thus, it is required to use resin compositions having flame retardancy but not including halogen compound (halogen-free) as an insulation material of insulated wires and cables.

One of known halogen-free flame-retardant resin compositions used for insulated wires and cables is a composition in which, e.g., a metal hydroxide as a halogen-based flame retardant, such as magnesium hydroxide, is added to a base polymer formed by mixing ethylene-vinyl acetate copolymer with polyolefin-based resin (see JP-A-2010-097881). A polybutylene naphthalate-based resin composition is also known, in which 40 to 150 parts by weight of polyester block copolymer (B), 10 to 30 parts by weight of magnesium hydroxide (C), 0.5 to 5 parts by weight of hydrolysis inhibitor (D) and 0.5 to 5 parts by weight of calcined clay (inorganic porous filler) (E) are contained per 100 parts by weight of polybutylene naphthalate resin (A) (see JP-A-2010-121112).

### SUMMARY OF THE INVENTION

It is an object of the invention to provide a halogen-free flame-retardant resin composition that allows propagation of flame to be suppressed by formation of a char layer at the time of combustion, as well as an insulated wire and a cable that include a covering layer including the resin composition.
(1) According to one embodiment of the invention, a halogen-free resin composition comprises an engineering plastic as a main component comprising an aromatic ring,

wherein a thermal weight-change rate measured by a thermogravimetry (under conditions that a dry air as a purge gas is introduced and that heating is conducted from 40° C. at a temperature rise rate of 10° C./min) is not less than −60% when it is 430° C.

In the above embodiment (1) of the invention, the following modifications and changes can be made.
(i) The engineering plastic comprises one of polybutylene terephthalate (PBT), modified polyphenylene ether (PPE) and polybutylene naphthalate (PBN).
(ii) The halogen-free resin composition further comprises a halogen-free flame retardant except a phosphorus-based compound.
(iii) The halogen-free flame retardant comprises a metal hydroxide except an aluminum hydroxide.
(iv) The halogen-free flame retardant comprises a metal oxide.
(v) The halogen-free flame retardant comprises a silicone compound.
(2) According to another embodiment of the invention, an insulated wire comprises an insulation layer comprising the halogen-free resin composition according to the above embodiment (1) of the invention.
(3) According to another embodiment of the invention, a cable comprises the insulated wire according to the above embodiment (2) of the invention.
(4) According to another embodiment of the invention, a cable comprises a sheath comprising the halogen-free resin composition according to the above embodiment (1) of the invention.

### Effects of the Invention

According to one embodiment of the invention, a halogen-free flame-retardant resin composition can be provided that allows propagation of flame to be suppressed by formation of a char layer at the time of combustion, as well as an insulated wire and a cable that include a covering layer including the resin composition.

### BRIEF DESCRIPTION OF THE DRAWINGS

Next, the present invention will be explained in more detail in conjunction with appended drawings, wherein:

FIG. 1 is a cross sectional view showing an embodiment of an insulated wire in the present invention; and

FIG. 2 is a cross sectional view showing an embodiment of a cable in the invention.

### DETAILED DESCRIPTION OF THE PREFERRED EMBODIMENT

A halogen-free resin composition, an insulated wire and a cable in the embodiment of the invention will be described in detail below.

Halogen-Free Resin Composition

The halogen-free resin composition in the embodiment of the invention includes an engineering plastic having an aromatic ring as main component, wherein a thermal weight-change rate measured by a thermogravimetry (under conditions that a dry air as a purge gas is introduced and that heating is conducted from 40° C. at a temperature rise rate of 10° C./min) is not less than −60% when it is 430° C.

Engineering Plastic Having an Aromatic Ring

The halogen-free resin composition in the embodiment of the invention includes an engineering plastic having an aromatic ring as a main component. Here, the main component means not less than 50 mass % of the polymer constituting the halogen-free resin composition.

The engineering plastic having an aromatic ring used in the present embodiment is likely to form a char layer at the time of combustion and example thereof include polyethylene terephthalate (PET), polybutylene terephthalate (PBT), modified polyphenylene ether (PPE), polycarbonate (PC), polyamide (PA), polyphenylene sulfide (PPS), polyether ether ketone (PEEK), polyethylene naphthalate (PEN), polybutylene naphthalate (PBN) and polyethersulfone (PES) etc. which can be used alone or in combination of two or more. Among the above, polyethylene terephthalate (PET), polybutylene terephthalate (PBT), modified polyphenylene ether (PPE), polycarbonate (PC), polyether ether ketone (PEEK), polyethylene naphthalate (PEN) and polybutylene naphthalate (PBN) do not produce hazardous gases such as NOₓ or SOₓ at the time of combustion and are thus exemplary. It is more exemplary to use a resin selected from polybutylene terephthalate (PBT), modified polyphenylene ether (PPE) and polybutylene naphthalate (PBN).

Thermal Weight-Change Rate

A thermal weight-change rate of the halogen-free resin composition in the embodiment of the invention measured by a thermogravimetry (under conditions that a dry air as a purge gas is introduced and that heating is conducted from 40° C. at a temperature rise rate of 10° C./min) is not less than −60% when it is 430° C. (sample temperature). When an organic material is heated to around 430° C. by thermogravimetric technique, most of gas generated therefrom is flammable gas. This means that materials with a smaller weight-change are excellent in flame retardancy. In addition, a heat insulating effect is exhibited by formation of char layer at the time of combustion, which is effective for flame retardancy. Once the char layer is formed, the weight-change is reduced and, at the same time, the flammable gas is also reduced, resulting in high flame retardancy. The thermal weight-change rate is preferably not less than −55%, more preferably not less than −50%, still further preferably not less than −45%, and most preferably not less than −40%.

The thermal weight-change rate can be obtained as follows:

Thermal weight-change rate (%)={(weight after heating)−(weight before heating)/weight before heating}×100

The engineering plastic to be used is selected so that the thermal weight-change rate is not less than −60%. In addition, preferably, the engineering plastic mentioned above and the halogen-free resin composition described later are blended so that the thermal weight-change rate is not less than −60%.

The halogen-free resin composition in the embodiment of the invention may contain a polymer component other than the above-mentioned engineering plastic having an aromatic ring as long as the effect thereof is exhibited. In such a case, the contained amount of the engineering plastic having an aromatic ring is preferably not less than 80 mass % of the total polymer, more preferably not less than 90 mass %, still further preferably not less than 95 mass %, but most preferably 100 mass % (only the engineering plastic is included).

Halogen-Free Flame Retardant

The halogen-free resin composition in the embodiment of the invention exemplarily includes a halogen-free flame retardant other than phosphorus-based compounds. Metal hydroxides (except aluminum hydroxide), metal oxides and silicone compounds, etc., can be used as the halogen-free flame retardant other than phosphorus-based compounds. It is exemplary to use one or more selected from metal hydroxides (except aluminum hydroxide), metal oxides and silicone compounds.

Metal Hydroxide

The halogen-free resin composition in the embodiment of the invention exemplarily includes a metal hydroxide (except aluminum hydroxide). As the metal hydroxide, magnesium hydroxide is particularly preferable. Aluminum hydroxide is dehydrated at low temperature and is foamed at the time of processing the engineering plastic, hence, not exemplary. Note that, metal hydroxides are compounds which have an —OH bonded to metal element and are dehydrated by heating.

The metal hydroxide (except aluminum hydroxide) is preferably included in an amount of 10 to 30 parts by mass with respect to 100 parts by mass of the total polymer in the halogen-free resin composition, more preferably 15 to 25 parts by mass. When the content of the metal hydroxide is reduced, another halogen-free flame retardant is used together so that the thermal weight-change rate is not less than −60%.

Metal Oxide

The halogen-free resin composition in the embodiment of the invention preferably contains a metal oxide (a compound having an —O bonded to metal element) because it is effective to form a char layer. Examples of metal oxide include aluminum oxide, iron oxide, titanium oxide, manganese oxide, magnesium oxide, zirconium oxide, zinc oxide, molybdenum oxide, cobalt oxide, bismuth oxide, chromium oxide, tin oxide, antimony oxide, nickel oxide, copper oxide, tungsten oxide, silica, zinc stannate, zinc borate, zinc metaborate and zinc metaborate barium, etc. It is particularly exemplary to use zinc compounds, titanium oxides and magnesium oxides, etc., which are used for general purposes and do not significantly change other characteristics such as heat resistance.

The metal oxide is preferably included in an amount of 1 to 10 parts by mass with respect to 100 parts by mass of the total polymer in the halogen-free resin composition, more preferably 3 to 8 parts by mass. When the content of the metal oxide is reduced, another halogen-free flame retardant is used together so that the thermal weight-change rate is not less than −60%.

Silicone Compound

The halogen-free resin composition in the embodiment of the invention preferably includes a silicone compound. Examples of silicone compound include dimethylpolysiloxane and methyl phenyl polysiloxane, etc. The silicone compound may be modified by introducing a polar group into one or both terminals in order to improve dispersibility. The polar group (modifying group) can be a hydroxyl group, a carboxyl group and an epoxy group, etc. A silane coupling agent may be used, if required. Examples thereof include vinylsilane compounds such as vinyltrimethoxysilane, vinyltriethoxysilane and vinyl tris(β-methoxyethoxy)silane, aminosilane compounds such as γ-aminopropyltrimethoxysilane, γ-aminopropyltriethoxysilane, N-(β-aminoethyl)-γ-aminopropyltrimethoxysilane, (β-aminoethyl)-γ-aminopropylmethyldimethoxysilane and N-phenyl-γ-aminopropyltrimethoxysilane, epoxy silane compounds such as β-(3,4-epoxycyclohexyl)ethyltrimethoxysilane, γ-glycidoxypropyltrimethoxysilane and γ-glycidoxypropyl methyldiethoxysilane, acrylic silane compounds such as γ-methacryloxypropyltrimethoxysilane, polysulfide silane compounds such as bis(3-(triethoxysilyl)propyl)disulfide and bis(3-(triethoxysilyl)propyl)tetrasulfide, and mercaptosilane compounds such as 3-mercaptopropyl trimethoxysilane and 3-mercaptopropyl triethoxysilane, etc.

The silicone compound is preferably included in an amount of 5 to 25 parts by mass with respect to 100 parts by mass of the total polymer in the halogen-free resin composition, more preferably 10 to 20 parts by mass. When the content of the silicone compound is reduced, another halogen-free flame retardant is used together so that the thermal weight-change rate is not less than −60%.

Other Additives

To the halogen-free resin composition in the embodiment of the invention, it is possible, if necessary, to add additives such as ultraviolet absorbers, light stabilizers, softeners, lubricants, colorants, reinforcing agents, surface active agents, inorganic fillers, plasticizers, metal chelators, foaming agents, compatibilizing agents, processing aids and stabilizers, in addition to the above-mentioned flame retardants.

In addition, cross-linking may be performed in the embodiment of the invention. The cross-linking method is, e.g., electron beam crosslinking or silane crosslinking, etc. A crosslinking aid may be added, if required.

Insulated Wire

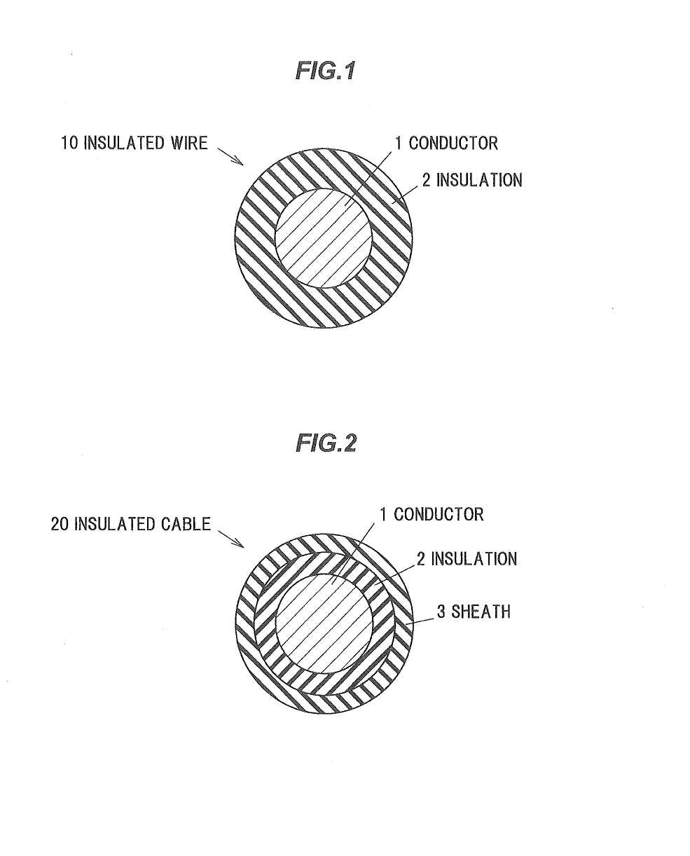

FIG. 1 is a cross sectional view showing an embodiment of an insulated wire in the invention.

As shown in FIG. 1, an insulated wire 10 in the present embodiment is provided with a conductor 1 formed of a general-purpose material, e.g., tin-plated copper, etc., and an insulation 2 covering an outer periphery of the conductor 1.

The insulation 2 is formed of the halogen-free resin composition in the embodiment of the invention.

In the present embodiment, the insulation layer may be a single layer or may have a multilayer structure. Specifically, the multilayer structure is, e.g., a structure obtained by extrusion-coating of a polyolefin resin as layers other than the outermost layer and the halogen-free resin composition as the outermost layer. Examples of the polyolefin resin include low-density polyethylene, EVA, ethylene ethyl acrylate copolymer, ethylene methyl acrylate copolymer, ethylene-glycidyl methacrylate copolymer and maleic anhydride polyolefin, etc., which can be used alone or as a mixture of two or more. A separator or a braid, etc., may be further provided, if required.

Rubber materials are also applicable as a material used for insulation layers other than the outermost layer. Examples thereof include ethylene-propylene copolymer rubber (EPR), ethylene-propylene-diene terpolymer rubber (EPDM), acrylonitrile butadiene rubber (NBR), hydrogenated NBR (HNBR), acrylic rubber, ethylene-acrylic ester copolymer rubber, ethylene-octene copolymer rubber (EOR), ethylene-vinyl acetate copolymer rubber, ethylene-butene-1 copolymer rubber (EBR), butadiene-styrene copolymer rubber (SBR), isobutylene-isoprene copolymer rubber (DR), block copolymer rubber having a polystyrene block, urethane rubber and phosphazene rubber, etc., which can be used alone or as a mixture of two or more.

In addition, the material of the insulation layers other than the outermost layer is not limited to the polyolefin resins and rubber materials listed above, and is not specifically limited as long as insulation properties are obtained.

Cable

FIG. 2 is a cross sectional view showing an embodiment of a cable in the invention.

As shown in FIG. 2, a cable 20 in the present embodiment is provided with the insulated wire 10 in the present embodiment and a sheath 3 covering an outer periphery of the insulated wire 10. The insulated wire may be a single-core wire or a multi-core wire such as a two-core wire.

The sheath 3 is formed of the halogen-free resin composition in the embodiment of the invention.

In the present embodiment, the sheath may be a single layer or may have a multilayer structure. Specifically, the multilayer structure is, e.g., a structure obtained by extrusion-coating of a polyolefin resin as layers other than the outermost layer and the halogen-free resin composition as the outermost layer. Examples of the polyolefin resin include low-density polyethylene, EVA, ethylene ethyl acrylate copolymer, ethylene methyl acrylate copolymer, ethylene-glycidyl methacrylate copolymer and maleic anhydride polyolefin, etc., which can be used alone or as a mixture of two or more. A separator or a braid, etc., may be further provided, if required.

Although the cable in the present embodiment is shown as an example in which the insulated wire 10 in the present embodiment is used, it is also possible to use an insulated wire using a general-purpose material. Insulated wires using general-purpose materials are used in Examples described below.

### EXAMPLES

The cable of the invention will be specifically described below in reference to Examples. It should be noted that the following examples are not intended to limit the scope of the invention in any way.

### Examples 1 to 8 and Comparative Examples 1 to 3

The cable shown in FIG. 2 was made as follows.

(1) Components shown in Table 1 or 2 were blended, were kneaded by a twin-screw extruder at 250° C. and were then formed into pellets (pelletization), thereby obtaining a sheath material.

(2) A conductor (19 strands'0.26 mm diameter) was double-coated with low-density polyethylene (Trade name: Evolue SP1510 manufactured by Prime Polymer Co., Ltd.) as an insulation and with the sheath material obtained in the above (1) as a sheath by extrusion using a 65-mm extruder so that the insulation has a thickness of 0.1 mm and the sheath has a thickness of 0.16 mm. An electron beam was irradiated thereon at 10 Mrad for cross-linkage, thereby obtaining a cable.

Each of the obtained cables was evaluated by the following evaluation tests. Tables 1 and 2 show the evaluation results.

Evaluation Tests

(1) Thermal Weight-Change Rate

Using thermogravimetric technique, the sheath of the cable was heated from 40° C. to 900° C. at a temperature rise rate of 10° C/min in a purge gas of dry air. The thermal weight-change rate of not less than −60% when it is 430° C. was regarded as “◯ (pass)” and less than −60% was regarded as “X (fail)”.

(2) Flame-Retardant Test

For evaluating flame retardancy, a vertical flame test was conducted in accordance with EN 60332-1-2. A 550 mm-long cable was held vertical, a flame was applied to a position 475 mm from the upper end for 60 seconds and the cable was detached. The cables with remaining flame self-extinguished within a range of 50 mm to 540 mm from the upper end were regarded as “◯ (pass)” and the cables with remaining flame extended beyond this range were regarded as “X (fail)”.

Overall Evaluation

For overall evaluation, the cables which passed all tests were evaluated as “◯ (acceptable)” and the cables which failed any of the tests were evaluated as “X (unacceptable)”.

TABLE 1
Examples (Unit of blending amount: parts by mass)

| | Examples | | | | | | | |
|---|---|---|---|---|---|---|---|---|
| Items | 1 | 2 | 3 | 4 | 5 | 6 | 7 | 8 |
| PBN ¹⁾ | 100 | 100 | 100 | 100 | | | | |
| Modified PPE ²⁾ | | | | | 100 | | | |
| PBT ³⁾ | | | | | | 100 | 100 | 100 |
| Dimethylpolysiloxane ⁴⁾ | | | 15 | 15 | | | 15 | 15 |
| Titanium oxide ⁵⁾ | | 5 | | 5 | | | | 5 |
| Magnesium hydroxide ⁶⁾ | 20 | 20 | 20 | 20 | | 20 | 20 | 20 |
| Thermal weight-change rate (%) | −35 | −30 | −45 | −40 | −15 | −45 | −60 | −55 |
| | ◯ | ◯ | ◯ | ◯ | ◯ | ◯ | ◯ | ◯ |
| Flame retardant test | ◯ | ◯ | ◯ | ◯ | ◯ | ◯ | ◯ | ◯ |
| Overall evaluation | ◯ | ◯ | ◯ | ◯ | ◯ | ◯ | ◯ | ◯ |

¹⁾ Trade name: TQB-OT manufactured by Teijin Chemicals Ltd.
²⁾ Trade name: WCV-063-111 manufactured by SABIC (Saudi Basic Industries Corporation)
³⁾ Trade name: NOVADURAN 5026 manufactured by Mitsubishi Engineering-Plastics Corporation
⁴⁾ Trade name: KF96-100CS manufactured by Shin-Etsu Chemical Co., Ltd.
⁵⁾ Trade name: R-820 manufactured by Ishihara Sangyo Kaisha, Ltd.
⁶⁾ Trade name: Kisuma 5L manufactured by Kyowa Chemical Industry Co., Ltd.

TABLE 2
Comparative Examples (Unit of blending amount: parts by mass)

| | Comparative Examples | | |
|---|---|---|---|
| Items | 1 | 2 | 3 |
| PBT³⁾ | 100 | 100 | 100 |
| Dimethylpolysiloxane⁴⁾ | | 15 | |
| Magnesium hydroxide⁶⁾ | | | 10 |
| Thermal weight-change rate (%) | −90 | −85 | −65 |
| | X | X | X |
| Flame retardant test | X | X | X |
| Overall evaluation | X | X | X |

As shown in Table 1, Examples 1 to 8 passed all tests (all “◯”) and the overall evaluation is thus rated as “◯”.

In Examples 1 to 4 in which polybutylene naphthalate (PBN) was used as a polymer of the sheath material, the thermal weight-change rate was not less than −45%.

In Example 5 in which modified polyphenylene ether (PPE) was used as a polymer of the sheath material, the thermal weight-change rate was −15%.

In Examples 6 to 8 in which polybutylene terephthalate (PBT) was used as a polymer of the sheath material, the thermal weight-change rate was not less than −60%.

As shown in Table 2, Comparatives Example 1 to 3 had a thermal weight-change rate of −65% to −90% and failed the flame retardant test even though polybutylene terephthalate (PBT) was used as a polymer of the sheath material, hence, the overall evaluation is rated as “X”.

The above results revealed that not less than −60% of thermal weight-change rate is essential in order to pass the flame retardant test.

Although the invention has been described with respect to the specific embodiment for complete and clear disclosure, the appended claims are not to be therefore limited but are to be construed as embodying all modifications and alternative constructions that may occur to one skilled in the art which fairly fall within the basic teaching herein set forth.

What is claimed is:

1. A halogen-free resin composition, comprising an engineering plastic as a main component comprising an aromatic ring,
wherein a thermal weight-change rate measured by a thermogravimetry (under conditions that a dry air as a purge gas is introduced and that heating is conducted from 40° C. at a temperature rise rate of 10° C./min) is not less than −60% when it is 430° C.

2. The halogen-free resin composition according to claim 1, wherein the engineering plastic comprises one of polybutylene terephthalate (PBT), modified polyphenylene ether (PPE) and polybutylene naphthalate (PBN).

3. The halogen-free resin composition according to claim 1, further comprising a halogen-free flame retardant except a phosphorus-based compound.

4. The halogen-free resin composition according to claim 3, wherein the halogen-free flame retardant comprises a metal hydroxide except an aluminum hydroxide.

5. The halogen-free resin composition according to claim 3, wherein the halogen-free flame retardant comprises a metal oxide.

6. The halogen-free resin composition according to claim 3, wherein the halogen-free flame retardant comprises a silicone compound.

7. An insulated wire, comprising an insulation layer comprising the halogen-free resin composition according to claim 1.

8. A cable, comprising the insulated wire according to claim 7.

9. A cable, comprising a sheath comprising the halogen-free resin composition according to claim 1.
